(19) United States
(12) Patent Application Publication
(10) Pub. No.: US 2002/0136504 A1
(43) Pub. Date: Sep. 26, 2002

(54) OPTO-ELECTRONIC INTERFACE MODULE FOR HIGH-SPEED COMMUNICATION SYSTEMS AND METHOD OF ASSEMBLING THEREOF

(76) Inventor: Bogie Boscha, Metuchou, NJ (US)

Correspondence Address: Ilya Zborovsky, 6 Schoolhouse Way, Dix Hills, NY, 11746, US

(21) Appl. No.: 09/760,744

(22) Filed: Jan. 17, 2001

(51) Int. Cl. G02B 6/42

(52) U.S. Cl. 385/91; 385/93; 385/88

(57) ABSTRACT

The invention discloses a compact, reliable, and miniaturized opto-electronic interface module for high-speed communication systems and a method of assembling thereof. The device comprises a microlens element, sandwiched between a photodetector with a working area having a diameter of 3 to 12 μm, and a glass ferrules with an optical fiber inserted into the ferrules. The end face of the optical fiber is spaced from the microlens at a distance that ensures accurate focusing of the light beam emitted from the fiber to the center of the photodetector. Automatic alignment of the optical fiber with the microlens is ensured at a stage of assembling due to a snug fit of the lens into the opening of the ferrule. The output lead wire of the photodetector is connected to a digital logic via a trans-impedance amplifier (TIA) with the use of microwave-stripline technique for matching impedance to ensure efficient transfer/conversion of optical signals to electrical. The optical and electrical components of the module can be organized in an array or a matrix pattern. An increase in bit rate of transmission through the interface is ensured due to decrease in the dimensions of light-receiving areas of the photodetectors and due to a special geometry of self-aligned light-guiding, light-focusing, and light-transmitting components of the device.

### FIELD OF THE INVENTION

The present invention relates to the field of optical fiber communication systems, in particular to optical to electronic interfaces for high-speed communication systems and to a method of assembling thereof. The device of the invention may find application as an interface between an optical communication line, such as DSL, a fiber communication system, and a data acquisition system, such as a personal computer, telephone, or the like.

### BACKGROUND OF THE INVENTION

Fiber optic communication technology has been developing at a rapid pace. One of the problems, which the optical communication systems confronts with an increase in the bandwidth demand, is an interface between lines of a multiple-channel optical communication system, such as, e.g., a long-distance fiber optic transport line, where it is desirable to increase distances between repeaters for cost-efficient signal transmission, or a digital subscriber line (DSL), and a data-acquisition system, such as, e.g., a personal computer. Such an interface has to satisfy bandwidth requirements with respect to reduced noise, as well as to provide an improved reliability of data transmission and constantly increasing data exchange rates between the multiple-channel communication systems and the data receiving terminals. For example, strict requirements to reliability of data transmission demand that a bit/error ratio (a unit according to Bell Core Specification) be within the range of less than 10⁻¹² and that the speed of data transmission be at the level of 2.5 Gbits/sec, typically up to 10 Gbits/sec, and even up to 40 Gbits/sec.

However, the design of existing opto-electronic interfaces currently used for data voice and video transmission stays behind modern technical capabilities of data transmission and data acquisition systems, while the bandwidth demand constantly increases.

In addition to high technical requirements to characteristics of the transmitting-receiving units, in order to maintain competitive positions, the optical to electronic interfaces must comply with the current industrial trend toward miniaturization of the electronic and optical components for high-density packaging and at the same time to allow a decrease in the production cost. For example, there is a need for higher number of communication lines versus cabinet space requirement availability.

An example of an opto-electronic interface of the aforementioned type is disclosed in U.S. Pat. No. 5,428,704 issued to M. S. Lebby et al. in 1995. The device of this patent comprises a connector with alignment means, such as pins, and with a central opening or openings for insertion of an optical fiber (fibers). The alignment pins are inserted into the guide openings on the mating surface of a photodetector holder that supports a photodetector (photodetectors), which is (are) aligned with the optical fiber core (cores). The device of the aforementioned patent is designed for a photodetector such as a photodiode (a-i-n photodiode), or the like with the surface of the working area comparable with the cross section or the outer diameter of the optical fiber clad. It can be assumed that the diameter of the optical fiber clad should be within the range of 50 to 150 μm, while the optical fiber core may have a diameter of 4 to 9 μm.

Furthermore, provision of guide pins and holes will not allow miniaturization of the opto-electronic interface. This is because in order to ensure reliable insertion of the pins into the guide openings, the pins must be sufficiently strong and rigid, and this is impossible without increasing the diameter of the pins. Furthermore, the guide pins must be located on both sides of the photodetector, and a distance between them increases the overall dimensions of the interface as a whole. In this device, alignment of the optical fiber with the sensor is carried out through the use of the aforementioned alignment pins and guide openings. The manufacture of these elements is complicated and expensive. Once these alignment elements are produced, they do not allow any adjustment in the position of optical fibers with respect to the photodetector. Furthermore, optical signal losses are higher in molded plastic waveguides or light pipes. Although U.S. Pat. No. 5,428,704 also described an embodiment for a plurality of optical fibers connectable to a plurality of photodetectors, for the same reasons as described above, such a device is not suitable for packing a large amount of optical fibers into a small space which may be required, e.g., for a connector to a port of a portable computer.

Furthermore, some modern photodetector arrays have sensors with a very small photosensitive area (typically 3 to 10 μm). With commercially available single-mode optical fibers, it would be impossible to ensure efficient coupling of photons to the photosensitive area of the device of the aforementioned patent without the use of a special focusing system.

### OBJECTS OF THE INVENTION

It is an object of the present invention to provide a simple, compact, and reliable opto-electronic interface which is suitable for mass production, can be produced in a miniaturized modular form suitable for connection to a port of a personal computer, suitable for use in conjunction with high-speed voice data and video data transmission systems, facilitates focusing of optical beams emitted from the ends of optical fibers onto a very small photoreceiving areas, ensures automatic alignment of optical fibers with photodetectors during assembling, and functions as a combined mechanical holder of a fiber and a device for precision focusing onto the center of the photodetector.

### BRIEF DESCRIPTION OF THE DRAWINGS

FIG. 1A is a sectional view that illustrates coupling of the optical fiber with a miniature photodetector in accordance with the principle of the present invention.

FIG. 1B is a sectional view along the line 1B-1B of FIG. 1A.

FIG. 2A is a simplified plan view of a unit consisting of the interface device of the invention and a substrate with a hybrid circuitry of commercially produced electrical components.

FIG. 2B is a view similar to FIG. 2A for the arrangement with a trans-impedance amplifier formed on the substrate in combination with a photodetector.

FIG. 3 is a sectional view similar to the one of FIG. 1A for an array-type interface.

FIG. 4 is a simplified block diagram illustrating electrical connections between the components of the device of the invention.

FIG. 5 is a top view of interface modules of the invention for optical and electrical components arranged in a matrix form.

FIG. 6 is a three-dimensional view of a matrix-type interface module of the present invention with pin/slot connections with a hybrid circuitry.

### SUMMARY OF THE INVENTION

The invention discloses a compact, reliable, and miniaturized opto-electronic interface module for high-speed communication systems and a method of assembling thereof. The device comprises a microlens element, sandwiched between a photodetector with a working area having a diameter of 3 to 12 μm, and glass ferrules with optical fibers inserted into the ferrules. The end face of each optical fiber is spaced from the microlens at a distance that ensures accurate focusing of the light beam emitted from the fiber to the center of the photodetector. Automatic alignment of the optical fiber with the microlens is ensured at a stage of assembling due to a snug fit of the lens into the opening of the ferrule. The output lead wire of the photodetector with integrated pre-amplifier is connected to a digital logic via a trans-impedance amplifier (TIA) with the use of microwave-stripline technique for matching impedance to ensure efficient transfer/conversion of optical signals to electrical. In the case of photodetectors with integrated TIA, the outputs of the TIA are converted for connection to the digital clock-generating circuit. The entire assembly is encapsulated into a molded casing for use as a module with standard interface features such as sockets and pins for connection to personal computers, communication cabinets, or the like. An increase in bit rate of transmission through the interface is ensured due to decrease in the dimensions of light-receiving areas of the photodetectors and due to a special geometry of self-aligned light-guiding, light-focusing, and light-transmitting components of the device. This results in stable and efficient coupling of photons to laser diodes and amplifiers over a wide range of operation temperatures.

### DETAILED DESCRIPTION OF THE INVENTION

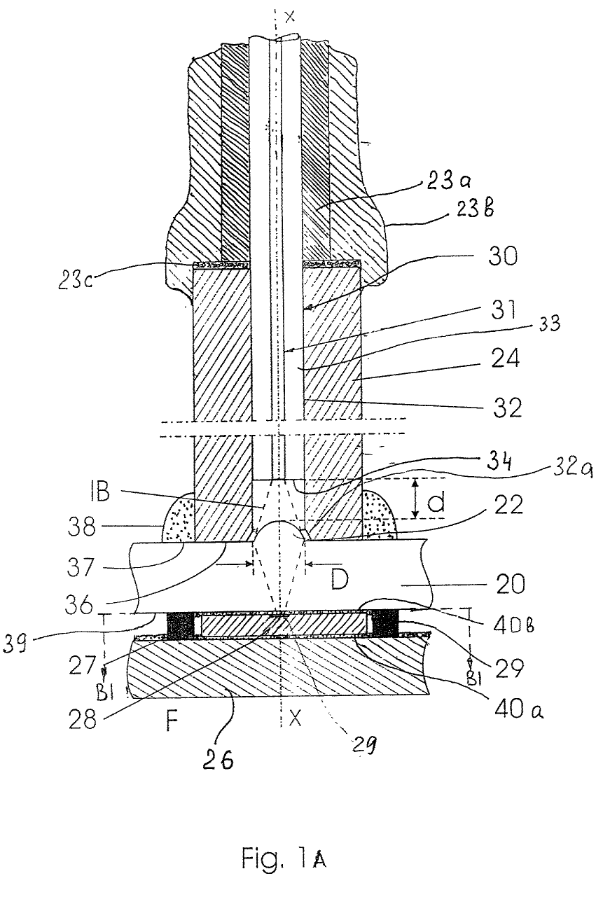

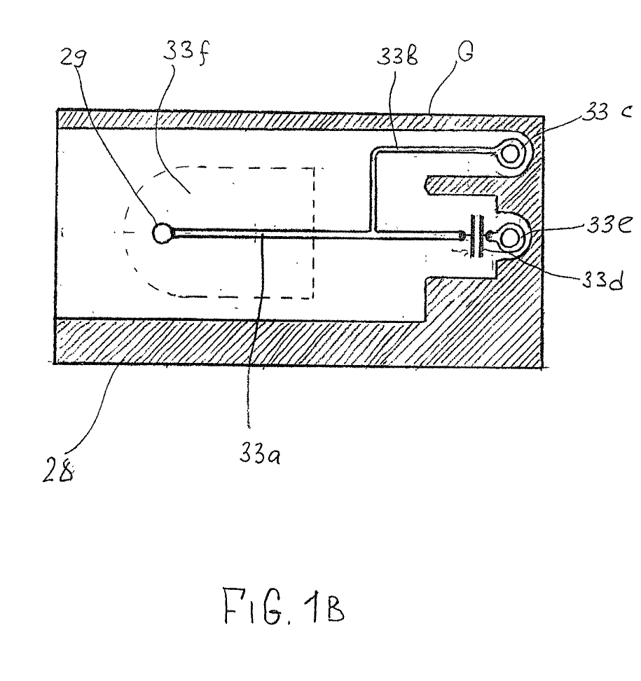

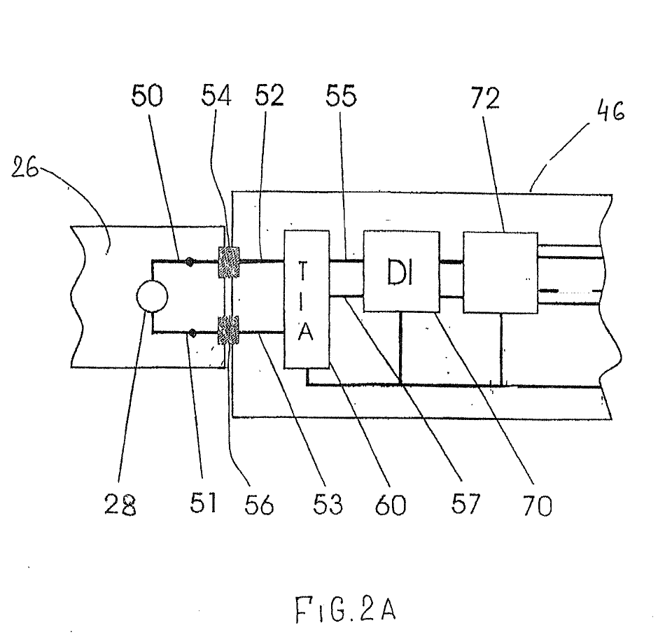

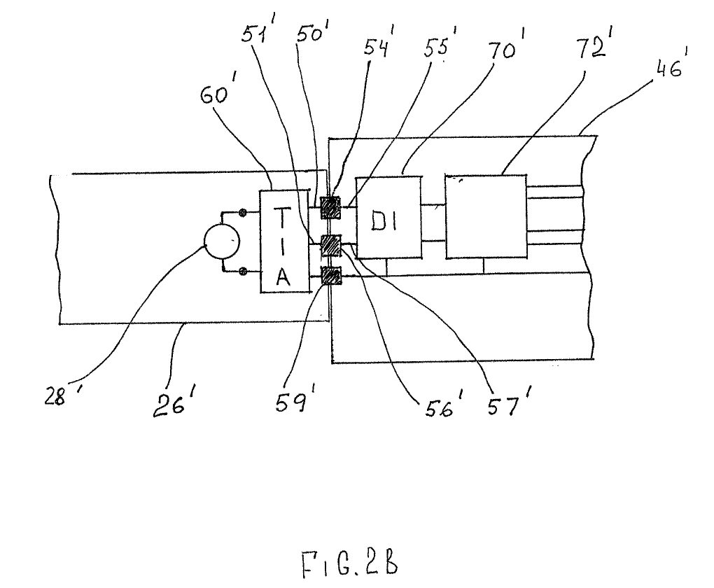

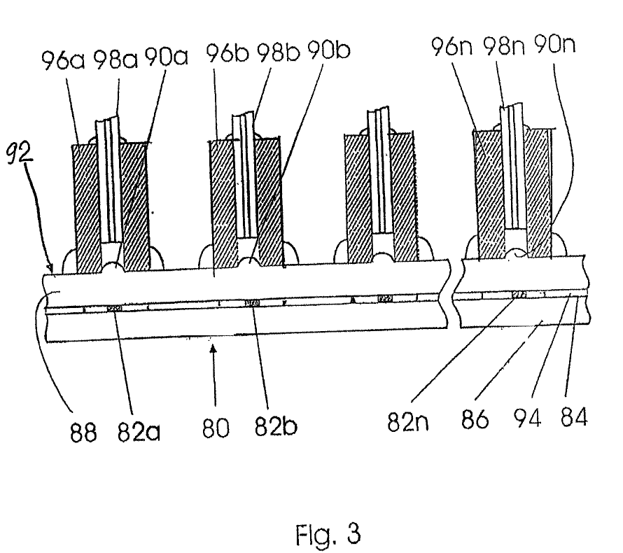

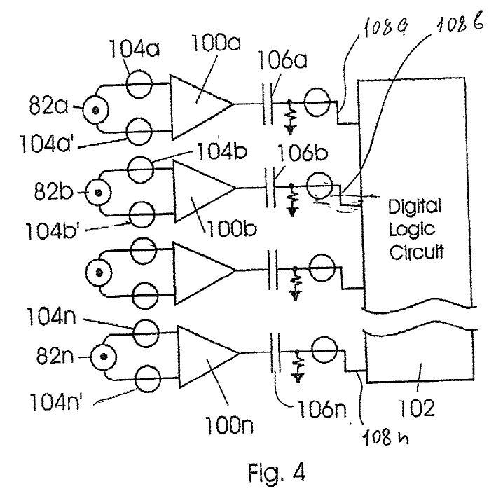

An opto-electronic interface module of the present invention is schematically shown in FIGS. 1-4, where FIG. 1A is a sectional view illustrating coupling of the optical fiber to a miniature photodetector in accordance with the principle of the present invention, FIG. 2 is a simplified plan view of a unit consisting of the interface device of the invention and a substrate with a hybrid circuitry of commercially produced electrical components, FIG. 3 is a sectional view similar to the one of FIG. 1A for an array-type interface, and FIG. 4 is a simplified block diagram illustrating electrical connections between the components of the device of the invention.

As shown in FIG. 1A, the opto-electronic interface module of the present invention, which hereafter will be referred to simply as a “device”, consists of a microlens element 20, which has a convex microlens 22 and which is sandwiched between a tubular glass ferrule 24 and a sensor-holding holder 26 with a photodetector 28 such as a photodiode. The backside of the microlens element is designated by reference numeral 39. The sensor-holding holder 26 may comprise, e.g., a silicon wafer type substrate with electric circuitry (for temperature sensing, impedance matching interface, thermoelectric cooling elements) formed, e.g., by metallization, as well as with temperature sensors formed by photolithography for direct monitoring of temperature under low-temperature conditions, etc. The backside of the holder 26 may be used as a ground shield for RF shielding (not shown). The entire optoelectronic assembly, consisting of the ferrule 24, the microlens element 20, and the photodetector 28 with the circuitry, etc., can be integrated into a package with a PC board with necessary electronics, e.g., for low-speed metro application.

Arrangement of the aforementioned components of a package are shown in FIG. 1B, which is a sectional view along the line 1B-1B of FIG. 1A. This is a simplified view, which is shown only as an example since many other arrangements are possible. In this drawing, the small circular area 29 inside the photodetector 28 designates an active planar zone of the photodetector made, e.g., of InP. Reference numerals 33a and 33b designate matching electroconductive stripes that connect the active zone 29 of the photodetector 28 with a power supply source (not shown) and a pre-amplifier 33f (shown conventionally), respectively. Connection to the power supply is carried out via a wire hole 33c, while connection to the pre-amplifier is carried out via a capacitor 33d and a wire hole 33e. The linear stripes are shown conventionally since for impedance matching they may have other configurations such as serpentine, S-shaped, or other forms. Symbol “G” designates a ground bus.

As seen in FIG. 1B, the pre- amplifier 33f can also be formed on the back surface of the photodetector 28′ or on the holder 26′.

As shown in FIG. 1A, an optical fiber 30 is inserted into a central opening 32 of the ferrule 24. The end face 34 of the optical fiber 30 is spaced from the nearest point of the microlens 22 at a distance “d” that ensures focusing of an optical beam IB onto the center of the active area 29 of the photodetector 28.

The microlens element 20 can be made of an optical material such as glass, quartz, or an optical plastic and may have a thickness that depends on the location of the focal plane of the microlens 22 for focusing a light beam IB emitted from the end face 34 of the fiber 30. The microlens 22, formed on the side of the microlens element 20 that faces the ferrule 24, may be an aspheric circular microlens, a cylindrical microlens, or a lens of any other type, provided that it projects from the plane of the microlens element 20. The microlens 22 should have a base diameter “D” equal to the diameter of the central opening 32 of the glass ferrule. The central opening 32 of the glass ferrule is fit on the part of the microlens 22 which projects above the upper surface 37 of the microlens element 20 so that the ferrule is self-aligned and centered on the lens coaxially with the optical axis X-X of an optical fiber 30 inserted into the central opening 32 of the ferrule.

As shown in FIG. 1A, the buffer layer 23a of the optical fiber is stripped off and the cladding layer 33 is inserted into the central opening 32 of the ferrule. For protection of the fiber from bending and breaking in the area of connection thereof to the ferrule 24, a rubber sleeve 23b can be fitted onto the buffer layer 23a. The end face of the buffer layer 23a is glued to the upper end face of the ferrule 24 by a glue layer 23c.

The base of the ferrule opening 32 may have a flared edge 32a to facilitate fitting onto the lens surface while maintaining perpendicularity of the optical axis X-X to the microlens element 20 and providing axial alignment of the optical axis to the ferrule end surface 36 and to the flat surface 37 of the lens element 20 with a minimum air-gap between them. This is important to allow for good and strong bonding between the ferrule 24 and lens element 20.

The base diameter “D” of the microlens and hence the diameter of the central opening 32 of the glass ferrule can be slightly, e.g., by 1 μm, greater than the diameter of the fiber cladding equal to 125 μm, if a standard optical fiber is inserted into the opening 32. Depending on the wavelength of the transmission, a typical fiber core of a single-mode fiber has a diameter within the range of 3 μm to 9 μm. In the case of a polarization-maintaining single-mode fiber, the characteristic transfer dimensions of the core 31 also falls into the same interval of 3 μm to 9 μm. Less than 1 micron tolerance on the diameter of the ferrule opening 32 (which is typically of 126 μm) and on the outer diameters of the fiber cladding and the base diameter “D” of the microlens should ensure tight fit of the ferrule on the lens and of the fiber inside the central opening 32. It is important for the end face of the ferrule 24 to have a high degree of flatness to ensure perpendicularity of the optical axis to the end face of the ferrule.

The optical fiber 30 can be fixed to the ferrule 24 by glue, e.g., UV curable glue, or by means of YAG-laser welding.

Since the ferrule 24 is fit with its opening 32 onto the microlens 22, the latter functions as a centering and aligning element for the ferrule 24, so that after fitting onto the microlens with the end face 36 of the ferrule in contact with the surface of the microlens element 20, the longitudinal axis of the ferrule, and hence of the optical fiber 30, is oriented strictly perpendicular to the plane of the microlens element and hence coaxially with the optical axis X-X of the microlens 22.

The ferrule 24 is fixed to the microlens element by means of a layer 38 of glue, preferably, UV-curable glue, such as Norland 61 or equivalent available from the manufacturers.

For efficient coupling, the lower surface of the photodetector 28 is attached to the flat surface of the holder 26 via a thin layer 40a of a glue (preferably thinner than 5 μm). The microlens assembly (which includes the microlens 20, the ferrule 24, etc.) is then attached to the upper flat surface of the holder 26 via a thin layer 40b (preferably thinner than 5 μm), which is optically matched to the lens element 20. Parallelism of the microlens element 20, holder 26, and photodetector 28 to each other is ensured by utilizing spacers 27 and 29. These spacers have a calibrated height of about 160 μm. The thickness of the photodetector is about 150 μm.

If necessary, the assembling can be carried out without the use of the spacers, since the surface of the holder 26 is produced with high flatness, and the supporting surfaces of the photodetector 28 are strictly parallel to each other and are relatively large (about 1 mm×0.7 mm).

The photodetector 28 may be a photodiode. It may have an active area as small as 3 to 12 μm. It should be noted that the beam spot focused on the surface of the active area 29 of the photodetector 28 has a diameter equal approximately to the half of the diameter of the active area 29. The focal point F of the microlens 22 is located in the center of the aforementioned active area 29 of the photodetector 28.

The assembling, focusing, and fixation of the aforementioned components of the optical unit shown in FIGS. 1A and 1B will be now described with reference to FIG. 2A and 2B, which are simplified plan views of units made in accordance with two different embodiments of a device of the invention consisting of the holder 26 (26′) and a substrate 46 (46′) with a hybrid circuitry which interconnects commercially produced electrical components such as a trans-impedance amplifier 60 (60′), a digitization/clock generator unit 70 (70′), and an output digital amplifier 72 (72′). The difference between the embodiments of FIGS. 2A and 2B consists in that in the case of FIG. 2A the trans-impedance amplifier 60 is formed on a substrate 46 with a hybrid circuitry, while in the case of FIG. 2B the trans-impedance amplifier 60′ is formed on the holder 26′ in combination with photodetector 28′.

Since the assembling procedure for the arrangements of FIGS. 2A and 2B are almost identical, the assembling will be further described only for the embodiment of FIG. 2A.

An electric pattern for electrical connections of the photodiode 28 to the trans-impedance amplifier 60 is formed by photolithography on the surface of the holder 26. At the same time, the impedance matching stripes, such as 33a and 33b, are formed on the surface of the photodetector 28. The electrical components of the unit are connected to appropriate devices located on the backside of the holder 26 via wire holes, such as 33e and 33c (FIG. 1B).

Then a thin layer 40a of a UV curable glue is applied onto the surface of a holder 26. The photodetector 28 is placed onto the glue layer 40a for attaching to the holder 26. At the same time, the electric terminals 33c and 33e of the photodetector 28 are brought in contact with the terminals on the surface of the holder 26 for connection to electrical components of the package. In other words, the photodiode 28 is placed onto the holder 26 to a marked position in which the output terminals 50 and 51 of the holder 26 are aligned to the terminals 52 and 53 of the trans-impedance amplifier 60 on the substrate 46 (FIG. 2A).

For high-frequency operation of the system, e.g., with the frequency of about 40 GHz, the output of the photodetector 28 must be impedance-matched to the input on terminals 52 and 53 of the trans-impedance amplifier 60 and to input on terminals 55 and 57 of the digitization unit 70 via the trans-impedance amplifier 60. The high-frequency operation is also ensured due to the use of microstrips 50, 51, 52, 53, 55, and 57 between the components shown in FIG. 2.

Alignment of microstrips with the respective terminals and subsequent connections between the terminals, e.g., in points 54 and 56, e.g., by YAG-laser welding or soldering, are carried out under a microscope or with the use of a computer-controlled vision system (not shown).

After connecting the photodetector holder 26 to the hybrid circuitry substrate 46, the electronics is subjected to DC and RF testing of performance characteristics of the interface in a special test chamber (not shown), and the electrical pulses converted from optical pulses by the photodetector 28 are modulated at the operating frequency. Once the stripline interconnections passed the test, a microlens assembly consisting of the microlens element 20, ferrule 24 with the fiber 30, etc. is attached to the photodetector unit. This connection is performed with self-alignment of the optical fiber relative to the active area 29 of the photodetector 28. The alignment procedure consists in the following. The projection of the microlens 22 is aligned with the position of the working area of the photodiode 28 under a microscope. In other words, the center of the microlens 22 is aligned with the center of the working area of the photodiode 28. Once the alignment is achieved, the components are interconnected by curing the glue layer 40b, which has been preliminarily applied to the surface of the photodetector 28. The glue of the layer 40b must index-matched to the material of the lens element. Some of the glue covers the electric circuitry and thus protects it from humidity, dust, etc.

After connection of the microlens element 20 to the holder 26 is completed, the unit is again tested for operation. Once it passed the test, the glass ferrule 24 is positioned on the lens 22.

As has been describe above, the ferrule 24 fits with its flared or straight opening 32 onto the microlens 22 with a tight fit, so that the microlens 22 functions as a centering and aligning element for the ferrule 24. After fitting onto the microlens 22 with the end face 36 of the ferrule in contact with the surface of the microlens element 20, the longitudinal axis of the ferrule 24, and hence of the optical fiber 30, is oriented strictly perpendicular to the plane of the microlens element and hence coaxially with the optical axis X-X of the microlens 22. After the alignment, a layer 38 of a glue, e.g., a UV-curable or heat-curable glue, is applied onto the outside perimeter of the ferrule in the area of contact of the ferrule 24 with the surface of the lens element 20, whereby the ferrule is glued to the lens element by UV radiation of the layer 38.

An optical fiber 30 is prepared for insertion into the ferrule 24 by stripping the fiber buffer (not shown), and cleaving the core 31 and cladding 33 flat. The treated end of the fiber 30 is then inserted into the central hole 32 of the ferrule 24.

The fiber 30 is inserted until the end face 34 of the optical fiber 30 touches the lens 22, and the fiber 30 is moved up by means of a micropositioning mechanism (not shown) for a distance “d” required for focusing the beam 1B emitted from the end face 34 of the fiber to the center F of the photodetector 28.

The above description related to an opto-electronic interface module consisting of a single optical fiber and a single photodetector with an appropriate coupling and electrical connections. FIG. 3 shows an opto-electronic interface module that contains an array of photodetectors coupled to a plurality of optical fibers inserted into the central openings of the ferrules also arranged into an array.

More specifically, the device of the embodiment of the invention shown in FIG. 3 has an array 80 of individual photodetectors 82a, 82b, . . . 82n mounted on the surface 84 of a substrate 86. The substrate 86 supports a lens array 88 made of quartz, glass, etc., with individual microlenses 90a, 90b, . . . 90n formed on the surface 92 of the microlens array 88, e.g., by photolithography. The pitch between the microlenses 90a, 90b, . . . 90n is equal to the pitch between the individual photodetectors 82a, 82b, . . . 82n. The microlens array 88 is connected to the array 80 of individual photodetectors via a layer 94 of an index-matched material such as UV-curable glue. Reference numerals 96a, 96b, . . . 96n designate a plurality of glass or quartz ferrules self-aligned with the microlenses 90a, 90b, . . . 90n and containing optical fibers 98a, 98b, . . . 98n which may be connected to fibers, e.g., of a multiple-fiber communication line.

The materials, functions of components, assembling, and alignment procedures for individual microlenses, photodetectors, and other components of the array-type interface shown in FIG. 3 are the same as have been described in connection with the embodiment of the invention shown in FIGS. 1 and 2, including all impedance matching means.

FIG. 4 is a simplified electric circuit of the system of FIG. 3. In FIG. 4, reference numerals 100a, 100b, . . . 100n designate trans-impedance amplifiers connected between photodetectors 82a, 82b, . . . 82n and a digital logic circuit 102. The trans-impedance amplifiers 100a, 100b, . . . 100n are connected to output terminals of respective photodetectors 82a, 82b, . . . 82n via stripline connectors 104a, 104a′, 104b, 104b′ . . . 104n, 104n′. Similarly, the trans-impedance amplifiers 100a, 100b, . . . 100n are connected to the digital logic circuit 102 via RC circuits 106a, 106b, . . . 106n and stripline connectors 108a, 108b, . . . 108n. Similar to the previous embodiment, all electrical components are mounted on respective substrates and their terminals are interconnected via electrical circuitry patterns formed by photolithography.

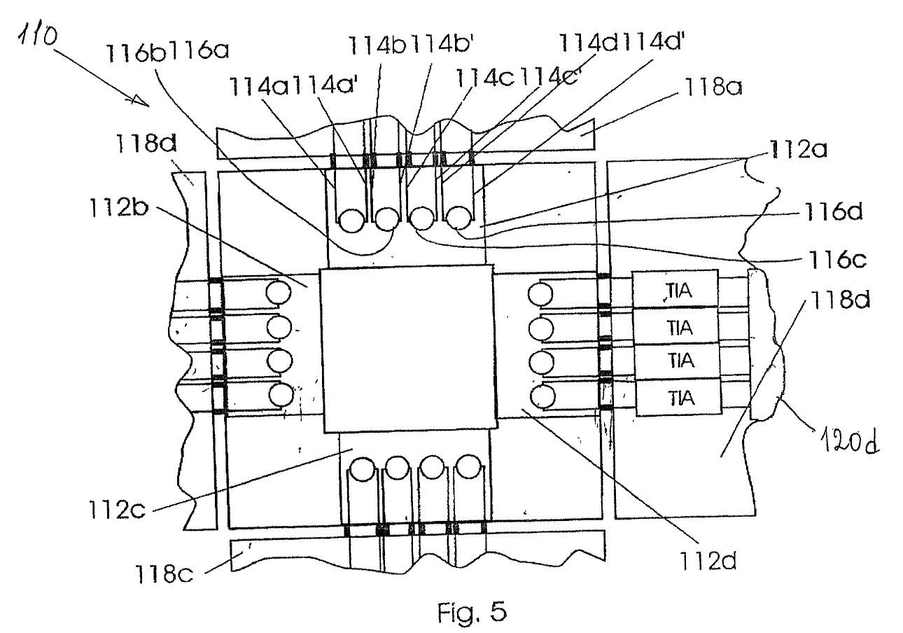

FIG. 5 illustrates another embodiment of the invention, where the optical and electrical components are arranged in a matrix form. For convenience of electrical connections, the matrices of photodetectors and optical components are formed by a plurality, e.g., four arrays of the type described in the second embodiment. Since the optical matrix has the same configuration as the matrix of the electrical components, only the latter is shown in FIG. 5. More specifically, a photodetector matrix 110 is formed by four arrays 112a, 112b, 112c, and 12d of the type shown in FIG. 4, which for convenience of access are arranged on the peripheries of a square-shaped configuration with output terminals 1 14a, 1 14b, 114c, 114d, 114e, . . . 114n of photodetectors 116a, 116b, 116c, 116d, 116e, . . . 116n. Reference numerals 118a, 118b, 118c, and 188d designate arrays of trans-impedance amplifiers. Each array 118a, 118b, 118c, and 188d is connected with a respective multiline digital logic circuit (only the digital logic circuit 120d is shown In FIG. 5). It is understood that the number of communication lines in each multiline logic circuit corresponds to the number of photodetectors in each photodetector array.

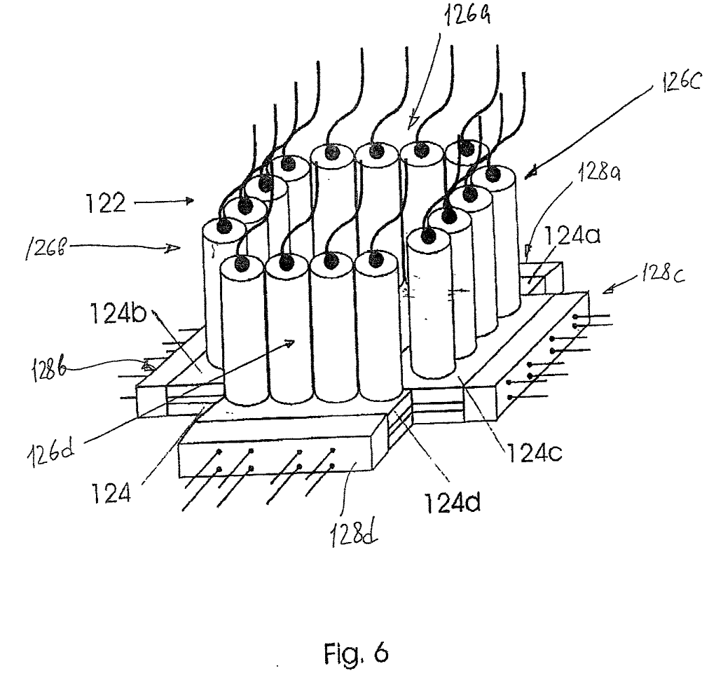

The interface module of the present invention can be produced in the form of a standard replaceable module of the type shown in FIG. 6 with pin/slot connections for interface with hybrid circuitry such as circuitry on the substrate 46 (FIG. 2A) that consists of commercially produced electrical components. FIG. 6 is a three-dimensional view of the interface module 122 of the present invention. The interface 122 consists of four photodetector arrays 124a, 124b, 124c, and 124d. Each photodetector array has the same construction as the one shown in FIG. 3. For example, the photodetector array 124c has an array of ferrules 126a, 126b, 126c, 126d, fitted with a tight fit onto respective lenses (not shown), which in turn are connected with respective photodetectors (not shown). Reference numerals 128a, 128b,128c, 128d designate output terminals of respective photodetectors. The entire module, including stripline bridges, can be encapsulated into a molded plastic shell which encapsulates all optical and electrical components of the interface module, except for the optical fibers and the outputs of the photodetectors.

The principle of operation of the electro-optical interface of the invention is the same for all the embodiments described above. Therefore the operation of the device will be described only with reference to the embodiment of FIGS. 1 and 2. A light signal is supplied to the optical fiber 30 from an optical data transmission system (not shown). A light beam 1B is emitted from the end face 34 of the optical fiber 30 and propagates with divergence onto the surface of the microlens 22 of the microlens element 20. Since the thickness of the microlens element 20 is selected so that the beam is focused onto the surface of the backside 39 of the microlens element, the beam will also be focused onto the center F of the working area 29 of the photodetector 28, which is in contact, via a very thin optically matched glue layer 40a, with the surface 39. The photodetector 28 converts the optical signal into an electrical signal which is generated on the output stripline terminals 50 and 51 (FIG. 2A) electrically connected with the photodetector 28. The electrical signal is sent through the stripline terminals 50 and 51 and the TIA 57 to the digital logic circuit 102 (FIG. 4). The stripline terminals 50 and 51, as well as the stripline connectors 52, 53 and 55, 57, etc., and the TIA ensure impedance matching between the interface module and the electric signal receiving bus (not shown).

Thus it has been shown that the present invention provides a simple, compact, and reliable opto-electronic interface which is suitable for mass production, can be produced in a miniaturized module form suitable for connection to a port of a personal computer, suitable for use in conjunction with high-speed voice data and video data transmission systems, facilitates focusing of optical beams emitted from the ends of optical fibers onto a very small photoreceiving areas, ensures automatic alignment of optical fibers with photodetectors during assembling, and functions as a combined mechanical holder of a fiber and a device for precision focusing onto the center of the photodetector.

Although the invention has been described and illustrated with reference to specific embodiments, it is understood that these embodiments should be construed as limiting the scope of application of the invention and that any modifications and changes are possible, provided they do not depart from the scope of patent claims. For example, the photodetector can be formed on a substrate together with the circuitry by means of planar technology. In the case of an array and matrix-type construction, flatness on the surface of the photodetector substrate mating with the surface of the lens substrate can be achieved by CMP planarization. The optical and electrical components may have different arrangements in arrays and matrices. The output terminals may have different configurations such as pins, holes, slits, etc. The interface module of the present invention can be used for interconnecting various optical data transmitting and electrical data receiving systems and can be utilized in personal computers, cellular telephones, TV sets, etc. The stripline interconnection technique can be carried out by various methods, provided that they ensure matching of impedances on the input and output sides.

What I claim is:

1. An optoelectronic interface module for converting optical signals into electrical signals comprising:
photosensitive unit having at least one photodetector with a working area;
at least one optical fiber;
combined optical self-focusing and fiber self-aligning means with an optical axis for focusing a light beam transmitted through said optical fiber onto the center of said working area and for aligning said optical fiber with said optical axis of said combined optical focusing and fiber-aligning means, said self-focusing and said self-aligning being taking place during assembling of said optoelectronic interface module; and
photodetector output means for output of said electrical signals.

2. The optoelectronic interface module of claim 1, wherein said combined optical self-focusing and fiber self-aligning means comprises a microlens element made of an optical material with at least one substantially circular convex microlens having a base diameter, a tubular ferrule with a central opening having a diameter that ensures a snug fit of said tubular ferrule on said microlens over said base diameter; and an optical fiber inserted into said ferrule and having a diameter that ensures a sliding fit of said optical fiber in said central opening of said ferrule, said optical fiber having an end face on the end inserted into said ferrule, said end face being spaced from said microlens at a distance that ensures the use of the entire aperture of said microlens when said light signals are transmitted through optical fiber to said working area of said photodetector.

3. The optoelectronic interface module of claim 2, wherein said central opening of said tubular ferrule has a flared end on the side facing said microlens.

4. The optoelectronic interface module of claim 2, wherein said microlens element has a thickness that ensures said self-focusing of said microlens on said center of said working area.

5. The optoelectronic interface module of claim 3, further provided with a digital logic unit and with at least one trans-impedance amplifier between said photodetector output means and said digital logic means.

6. The optoelectronic interface module of claim 3, further provided with a digital logic means and with at least one integrated pre-amplifier to the said photodetector output means and said digital logic means.

7. The optoelectronic interface module of claim 2, which contains a plurality of said microlenses and a plurality of said photodetectors, each microlens of said plurality of said microlenses being associated with respective photodetectors of said plurality of said photodetectors.

8. The optoelectronic interface module of claim 7, wherein said microlens element has a thickness that ensures said self-focusing of said microlenses on said center of said working areas of said photodetectors.

9. The optoelectronic interface module of claim 8, wherein said microlens element comprising a microlens array and said plurality of said photodetectors comprising a photodetector array.

10. The optoelectronic interface module of claim 8, further provided with a digital logic unit and with a plurality of trans-impedance amplifiers between said photodetectors and said digital logic means.

11. The optoelectronic interface module of claim 8, wherein said microlens element comprising a microlens matrix and said plurality of said photodetectors comprising a photodetector matrix.

12. The optoelectronic interface module of claim 11, further provided with a digital logic unit and with a plurality of trans-impedance amplifiers between said photodetectors and said digital logic means.

13. The optoelectronic interface module of claim 4, wherein all components of said interface, except for said optical fibers and said photodetector output means, are encapsulated in a molded plastic shell.

14. The optoelectronic interface module of claim 9, wherein all components of said interface, except for said optical fibers and said photodetector output means, are encapsulated in a molded plastic shell.

15. The optoelectronic interface module of claim 10, wherein all components of said interface, except for said optical fibers and said photodetector output means, are encapsulated in a molded plastic shell.

16. A method of assembling an opto-electronic interface module for converting optical signals from optical data transmission means into electrical signals received by electrical signal receiving means, comprising the steps of:
providing a photodetector-holding substrate with a prefabricated electric pattern;
placing at least one photodetector with output means on a predetermined place on said photodetector-holding substrate in which said output means are electrically connected to said electric pattern and securing said photodetector, said photodetector having a working area, said working area having a center;
providing a microlens element made of an optical material with at least one substantially circular convex microlens having a base diameter;
applying onto said photodetector-holding substrate from the side said photodetector a layer of a glue optically matched with said optical material;
placing said microlens element onto said layer of glue;
aligning position of said at least one microlens with the position of said center of said working area of said photodetector;
securing said microlens element to said photodetector-holding substrate by means of said glue;
providing a tubular ferrule having a central opening . . . or with flared opening at the base for optimum mating of the two surfaces . . . with a diameter that ensures a tight fit of said ferrule on said microlens over said base diameter;
fitting said ferrule with said central opening onto said microlens to provide said tight fit and to align said central opening with said microlens and said photodetector;
securing said ferrule on said microlens;
inserting an optical fiber having a diameter that ensures sliding fit of said optical fiber in said central opening into said central opening of said ferrule to a distance at which an optical beam emitted from said optical fiber is focused onto said center of said working area; and
securing said optical fiber to said ferrule.

17. The method of claim 16, further comprising a step of electrically testing performance of said interface after said step of securing said photodetector.

18.The method of claim 16, wherein said opto-electronic interface module contains a plurality of said microlenses and a plurality of said photodetectors, each microlens of said plurality of said microlenses being associated with respective photodetectors of said plurality of said photodetectors.

19. The method of claim 18, wherein said plurality of microlenses comprises a microlens array and said plurality of said photodetectors comprising a photodetector array.

20. The method of claim 16, wherein said plurality of said microlenses comprises a microlens matrix and said plurality of said photodetectors comprising a photodetector matrix.
